(19) United States
(12) Patent Application Publication
(10) Pub. No.: US 2021/0178713 A1
(43) Pub. Date: Jun. 17, 2021

(54) MANUFACTURING DEVICE AND MANUFACTURING METHOD FOR PNEUMATIC TIRE

(71) Applicant: TOYO TIRE CORPORATION, Itami-shi (JP)

(72) Inventor: Hirokazu Sakata, Itami-shi (JP)

(73) Assignee: TOYO TIRE CORPORATION, Itami-shi (JP)

(21) Appl. No.: 17/114,774

(22) Filed: Dec. 8, 2020

(30) Foreign Application Priority Data
Dec. 13, 2019 (JP) 2019-225698

(51) Int. Cl. B29D 30/24; B29D 30/06; B60C 9/02

(52) U.S. Cl. CPC B29D 30/24; B60C 9/02; B29D 30/0681

(57) ABSTRACT

A manufacturing device for a pneumatic tire in which a carcass ply includes a pair of ply pieces includes a molding drum, a drum drive device, a first supply device for supplying one of the ply pieces to the molding drum, a second supply device for supplying the other one of the ply pieces to the molding drum, and a control device that controls operation of the drum drive device and the first and second supply devices so that the one and the other one of the ply pieces are simultaneously supplied to the molding drum while the molding drum is rotationally driven, and two joint portions of the one and the other ply pieces are provided at different positions in the tire circumferential direction.

### CROSS-REFERENCE TO RELATED APPLICATIONS

This application claims priority of Japanese Patent Application No.: 2019-225698 filed on Dec. 13 2019, the content of which is incorporated herein by reference.

### BACKGROUND OF THE INVENTION

### Technical Field

The present invention relates to a manufacturing device and a manufacturing method for a pneumatic tire.

### Related Art

A carcass ply of a pneumatic tire disclosed in Japanese Patent No. 5629356 includes a first ply that is continuous between a pair of bead portions and a discontinuous second ply that is disposed on the outer side in the tire radial direction of the first ply. The second ply includes a pair of ply pieces extending from a tread portion to one of a pair of the bead portions. In the center of the tread portion, a region where neither of the two ply pieces exists, that is, a hollow portion is provided. The hollow portion of the second ply is intended to have two contradictory types of performance. One type of performance is rigidity (which contributes to improving steering stability) and cut resistance, and the other type of performance is weight reduction and rolling resistance reduction by the weight reduction.

### SUMMARY

The structure disclosed in Japanese Patent No. 5629356 can achieve the weight reduction and rolling resistance reduction by the weight reduction while ensuring rigidity and cut resistance. However, Japanese Patent No. 5629356 does not mention uniformity in the tire circumferential direction, and there is room for improvement regarding improvement in the uniformity in the tire circumferential direction. Further, when a pneumatic tire is manufactured, it is desired to manufacture the tire with excellent productivity.

An object of the present invention is to provide a manufacturing device and a manufacturing method for a pneumatic tire capable of manufacturing a pneumatic tire with excellent productivity while improving uniformity in the tire circumferential direction.

The present invention provides a manufacturing device for a pneumatic tire including a carcass ply stretching between a pair of bead cores disposed on both sides in a tire width direction, the carcass ply including a pair of ply pieces disposed separately on both sides in the tire width direction. The manufacturing device includes a molding drum, a drum drive device that rotationally drives the molding drum, a first supply device that supplies one ply piece of the pair of ply pieces to the molding drum, a second supply device that supplies the other ply piece of the pair of ply pieces to the molding drum, and a control device that controls operation of the drum drive device, the first supply device, and the second supply device so that the one and the other ply pieces are simultaneously supplied to the molding drum while the molding drum is rotationally driven, and two joint portions in which both end portions in a tire circumferential direction of the one and the other ply pieces are joined in a manner overlapping each other are provided at different positions in the tire circumferential direction.

By the present configuration, in the pneumatic tire, in a case where the carcass ply includes a pair of the ply pieces disposed separately on both sides in the tire width direction, the two joint portions of a pair of the ply pieces are provided at different positions in the tire circumferential direction. For this reason, as compared with the case where the two joint portions are provided at the same position in the tire circumferential direction, the joint portions are dispersed in the tire circumferential direction and uniformity in the tire circumferential direction of the pneumatic tire can be improved.

The joint portion of the ply piece has increased rigidity as compared with the non-joint portion of the ply piece. For this reason, the joint portion of the ply piece is less likely to bulge and deform than the non-joint portion when the tire is filled with internal pressure and bulged and deformed. Therefore, the joint portion of the ply piece may appear as a dent in the pneumatic tire.

By providing the two joint portions of a pair of the ply pieces at different positions in the tire circumferential direction, the dents caused by the two joint portions are dispersed in the tire circumferential direction and uniformity in the tire circumferential direction can be improved as compared with the case where the two joint portions are provided at the same position in the tire circumferential direction.

In the manufacturing of the pneumatic tire, the one and the other ply pieces are simultaneously supplied to the molding drum while the molding drum is rotationally driven, so that the supply time for supplying the one and the other ply pieces to the molding drum can be shortened and the manufacturing can be performed with excellent productivity, as compared with the case where the one and the other ply pieces are sequentially supplied to the molding drum. Therefore, the pneumatic tire can be manufactured with excellent productivity while the uniformity in the tire circumferential direction is improved.

The carcass ply includes the first ply including the central portion positioned on the inner side in the tire radial direction of the tread portion and a pair of the side portions extending to the inner side in the tire radial direction from both ends of the central portion, and the second ply having a pair of the ply pieces including the inner end portion disposed on the outer side in the tire radial direction with respect to the first ply and positioned in the tread portion and the side portion extending to the inner side in the tire radial direction from the inner end portion. The one and the other ply pieces of the second ply are supplied on the first ply wound around the molding drum.

The second ply on the first ply includes a pair of the ply pieces and is discontinuous. That is, between the inner end portions of a pair of the ply pieces, there is a hollow portion in which no ply exists. By employing the second ply having the hollow portion, the weight can be reduced as compared with the case where the second ply is one continuous ply. Further, rolling resistance can be reduced by weight reduction.

In the sidewall portion, two layers of plies, that is, the side portion of the first ply and the side portion of the ply piece of the second ply are disposed. By providing two layers of plies in the sidewall portion in this way, necessary cut resistance is ensured. Further, since plies are provided in two layers, necessary rigidity in the sidewall portion is ensured.

Therefore, it is possible to achieve weight reduction and reduction in rolling resistance due to the weight reduction while ensuring the rigidity and the steering stability due to the rigidity and the cut resistance, and, in addition, to manufacture the pneumatic tire with excellent productivity while achieving improvement in uniformity in the tire circumferential direction.

The first supply device preferably supplies the one ply piece to which a joining tape to be joined to the first ply is attached, and the second supply device preferably supplies the other ply piece to which a joining tape to be joined to the first ply is attached.

By the present configuration, the one and the other ply pieces of the second ply to which the joining tape is attached are supplied on the first ply, so that the first ply and the second ply can be joined strongly by the joining tape.

Further, the first supply device and the second supply device supply one and the other one of the ply pieces to the molding drum from the upper side and the lower side, respectively, and the control device controls operation of the drum drive device, the first supply device, and the second supply device so that the two joint portions of one and the other one of the ply pieces are provided at positions different by 180 degrees in the tire circumferential direction.

By the present configuration, one and the other one of the ply pieces are supplied to the molding drum from the upper side and the lower side, respectively, and the two joint portions are provided at positions different by 180 degrees in the tire circumferential direction, so that the two joint portions can be effectively dispersed in the tire circumferential, and the pneumatic tire can be manufactured with excellent productivity while the uniformity in the tire circumferential is improved.

The second supply device may include the holding portion that is disposed below the molding drum and holds the other one of the ply pieces, and the holding portion moving mechanism that moves the holding portion in the vertical direction. The holding portion holding the other one of the ply pieces may be moved to the upper side by the holding portion moving mechanism to supply the other one of the ply pieces to the molding drum.

By the present configuration, in a case where the other one of the ply pieces of the second ply is supplied to the molding drum from the lower side, the other one of the ply pieces is moved upward while being held by the holding portion and supplied to the molding drum. Accordingly, the other one of the ply pieces can be stably supplied to the molding drum.

The present invention also provides a manufacturing method for a pneumatic tire including a carcass ply stretching between a pair of bead cores disposed on both sides in a tire width direction, the carcass ply including a pair of ply pieces disposed separately on both sides in the tire width direction. The manufacturing method includes rotationally driving a molding drum, supplying one ply piece of the pair of ply pieces to the molding drum, and supplying the other ply piece of the pair of ply pieces to the molding drum, in which the one and the other ply pieces are simultaneously supplied to the molding drum while the molding drum is rotationally driven, so that two joint portions in which both end portions in a tire circumferential direction of the one and the other ply pieces are joined in a manner overlapping each other are provided at different positions in the tire circumferential direction.

By the present configuration, in the pneumatic tire, in a case where the carcass ply includes a pair of the ply pieces disposed separately on both sides in the tire width direction, the two joint portions of a pair of the ply pieces are provided at different positions in the tire circumferential direction. For this reason, as compared with the case where the two joint portions are provided at the same position in the tire circumferential direction, the joint portions are dispersed in the tire circumferential direction and uniformity in the tire circumferential direction of the pneumatic tire can be improved.

The joint portion of the ply piece has increased rigidity as compared with the non-joint portion of the ply piece. For this reason, the joint portion of the ply piece is less likely to bulge and deform than the non-joint portion when the tire is filled with internal pressure and bulged and deformed. Therefore, the joint portion of the ply piece may appear as a dent in the pneumatic tire.

By providing the two joint portions of a pair of the ply pieces at different positions in the tire circumferential direction, the dents caused by the two joint portions are dispersed in the tire circumferential direction and uniformity in the tire circumferential direction can be improved as compared with the case where the two joint portions are provided at the same position in the tire circumferential direction.

In the manufacturing of the pneumatic tire, the one and the other ply pieces are simultaneously supplied to the molding drum while the molding drum is rotationally driven, so that the supply time for supplying the one and the other ply pieces to the molding drum can be shortened and the manufacturing can be performed with excellent productivity, as compared with the case where the one and the other ply pieces are sequentially supplied to the molding drum. Therefore, the pneumatic tire can be manufactured with excellent productivity while the uniformity in the tire circumferential direction is improved.

According to the manufacturing device and the manufacturing method for a pneumatic tire according to the present invention, a pneumatic tire can be manufactured with excellent productivity while uniformity in the tire circumferential direction is improved.

### BRIEF DESCRIPTION OF THE DRAWINGS

The foregoing and the other features of the present invention will become apparent from the following description and drawings of an illustrative embodiment of the invention in which:

FIG. 1 is a meridian cross-sectional view of a pneumatic tire according to an embodiment of the present invention;

FIG. 2 is a meridian cross-sectional view of a tread portion of the pneumatic tire according to the embodiment of the present invention and its surroundings;

FIG. 3 is an enlarged view of Part III of FIG. 1;

FIG. 4 is an enlarged view of Part IV of FIG. 1;

FIG. 5 is a cross-sectional view of a first ply of a carcass ply along line V-V of FIG. 2;

FIG. 6 is a cross-sectional view of a second ply of the carcass ply along lines VIa-VIa and VIb-VIb of FIG. 2;

FIG. 7 is a schematic side view of a pneumatic tire for explaining a joint portion of the carcass ply;

FIG. 8 is an explanatory diagram for explaining a manufacturing method for a pneumatic tire; and

FIG. 9 is a schematic diagram of a manufacturing device for a pneumatic tire.

### DETAILED DESCRIPTION OF EMBODIMENTS

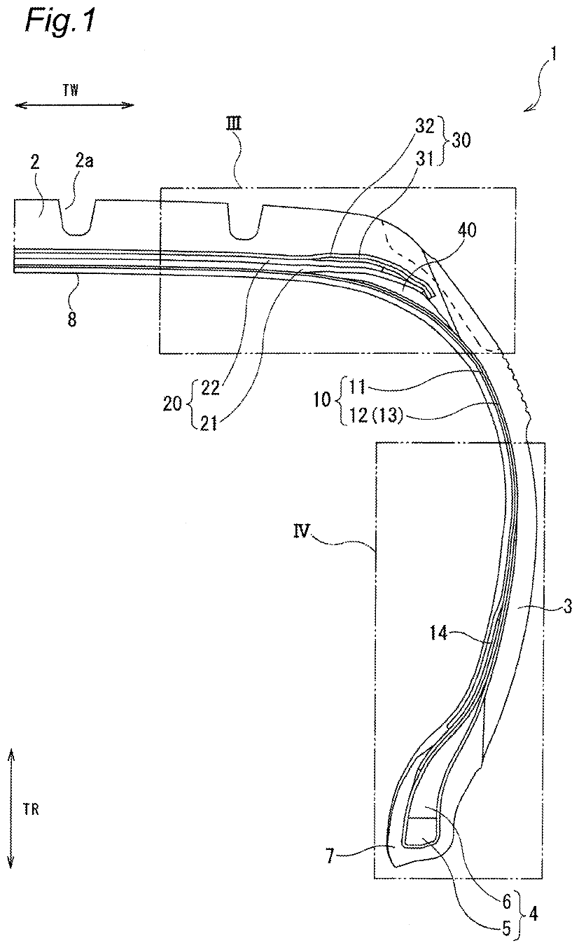

FIGS. 1 to 4 show a pneumatic tire 1 made from rubber according to an embodiment of the present invention.

The pneumatic tire 1 includes a tread portion 2, a pair of sidewall portions 3, and a pair of ring-shaped bead portions 4.

The tread portion 2 extends in the tire width direction (indicated by the reference numeral TW in FIG. 1). A groove 2a is provided on the surface, that is, the tread surface of the tread portion 2.

Each of a pair of the sidewall portions 3 extends from both ends in the tire width direction of the tread portion 2 to the inner side in the tire radial direction (reference numeral TR in FIG. 1).

A pair of the bead portions 4 are disposed on both sides in the tire width direction and disposed in end portions on the inner side in the tire radial direction of a pair of the sidewall portions 3. Each of the bead portions 4 includes a bead core 5 and a bead filler 6. The bead core 5 includes a large number of steel wires bundled in a ring shape. The bead filler 6 has a ring shape and is made from rubber that is harder than rubber that constitutes the tread portion 2 and the sidewall portion 3. The bead filler 6 includes a base end 6a disposed adjacent to the outer side in the tire radial direction of the bead core 5 and a tip end 6b on the side opposite to the base end 6a, and extends in a tapered shape from the base end 6a to the outer side in the tire radial direction toward the tip end 6b. Each of the bead portions 4 includes strip rubber 7 provided to wrap the bead core 5 and the bead filler 6.

The pneumatic tire includes a carcass ply 10 stretching in a toroidal shape between the bead portions 4. In the present embodiment, the carcass ply 10 includes a first carcass ply (hereinafter, referred to as “first ply”) 11 and a second carcass ply (hereinafter, referred to as “second ply”) 12. The second ply 12 is a ply having a hollow portion 13c, while the first ply 11 is a normal ply having no hollow portion. The first and second plies 11 and 12 will be described in detail later. An inner liner 8 is provided on the inner side of the carcass ply 10, that is, on the innermost peripheral surface of the pneumatic tire.

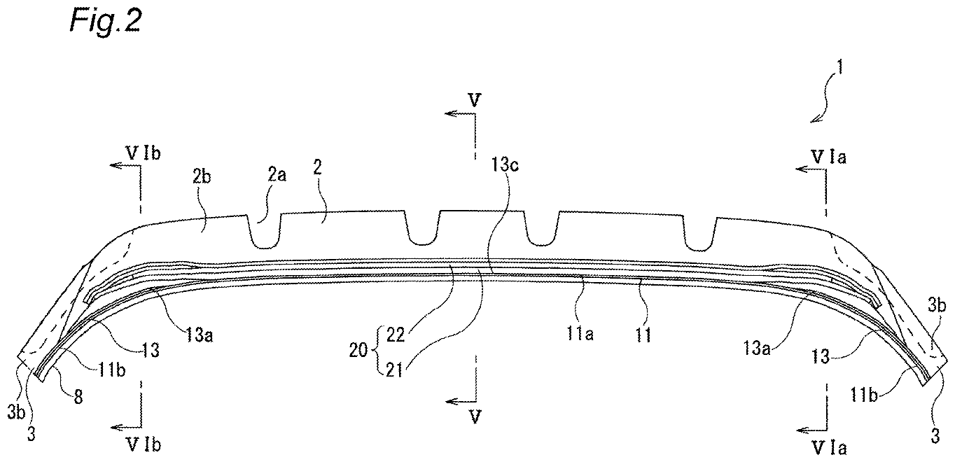

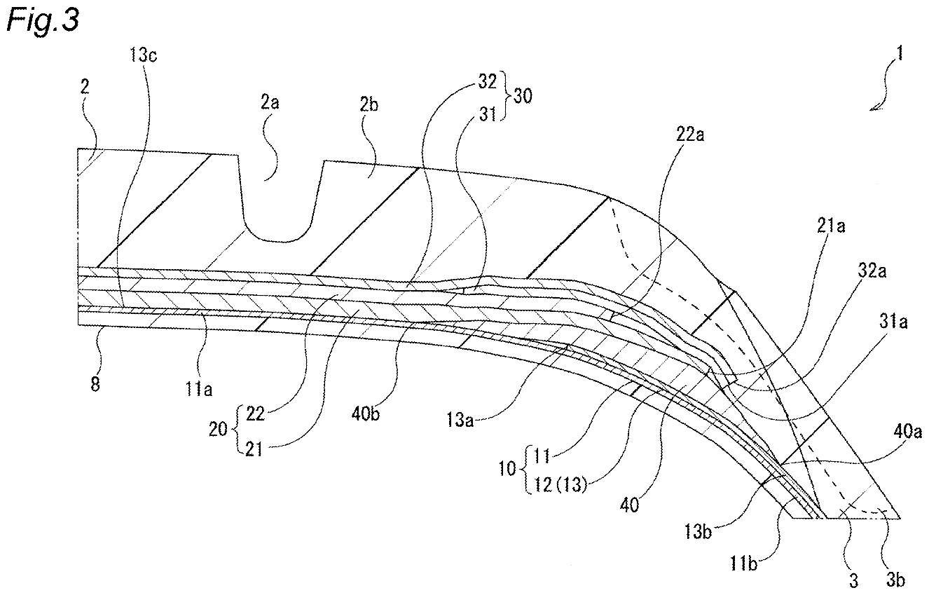

With reference to FIGS. 2 and 3, an endless belt layer 20 is provided on the tread portion 2, more specifically, between the carcass ply 10 and the tread portion 2. In the present embodiment, the belt layer 20 includes two belts 21 and 22. The belt 21 is disposed adjacent to the outer side in the tire radial direction of the carcass ply 10, and the belt 22 is disposed adjacent to the outer side in the tire radial direction of the belt 21. Further, in the present embodiment, the dimension in the tire width direction of the belt 21 in the lower layer is larger than the dimension in the tire width direction of the belt 22 in the upper layer, and an end portion 21a of the belt 21 is positioned closer to the outer side in the tire width direction than an end portion 22a of the belt 22. The belts 21 and 22 are formed by covering a belt cord made from steel or organic fiber with rubber. The belt layer 20 may be composed of one belt, or may include three or more belts.

An endless cap layer 30 is provided adjacent to the outer side in the tire radial direction of the belt layer 20. The cap layer 30 of the present embodiment includes a pair of narrow edge plies 31 that directly cover either of the end portions 21a and 22a of the belts 21 and 22. Further, the cap layer 30 of the present embodiment includes a wide cap ply 32, which is disposed adjacent to the outer side in the tire radial direction of the edge ply 31, as a single sheet that covers the entire belts 21 and 22 including the end portions 21a and 22a. The cap layer 30 may include one ply or three or more plies. Further, the cap layer 30 may be eliminated.

A pair of endless pads 40 made from rubber are disposed between both end portions on the outer side in the tire width direction of the belt layer 20 and the carcass ply 10. The cross-sectional shape of the pad 40 is a flat triangular shape. The positions in the tire width direction of the end portions 21a and 22a of the belts 21 and 22, the end portion 31a on the outer side in the tire width direction of the edge ply 31, and an end portion 32a of the cap ply 32 are set in a region between an end portion 40a on the outer side in the tire width direction of the pad 40 and an end portion 40b on the inner side, that is, a region where the pad 40 exists. The pad 40 may be eliminated.

The first and second plies 11 and 12 constituting the carcass ply 10 will be described.

The first ply 11 is a single ply, whereas the second ply 12 is a discontinuous ply having the hollow portion 13c as described above, and is composed of a pair of ply pieces 13. As will be described later, the first ply 11 and a pair of the ply pieces 13 are joined by a joining tape (joining member) 14. All of the first ply 11 and the ply pieces 13 of the second ply 12 are a strip-shaped sheet in which a plurality of cords arranged in parallel at intervals are covered with rubber.

The first ply 11 and the ply pieces 13 of the second ply 12 may have the same modulus (stress generated when a constant strain is applied) or may have different moduli. Further, the first ply 11 and the ply pieces 13 of the second ply 12 may have the same breaking strength (tensile load at which breaking occurs) or may have different breaking strengths.

The first ply 11 includes a central portion 11a positioned on the inner side in the tire radial direction of the tread portion 2, and a pair of side portions 11b extending from both ends in the tire width direction of the central portion 11a to the inner side in the tire radial direction. A pair of the side portions 11b are similarly configured. The side portion 11b is disposed in the sidewall portion 3. The individual side portions 11b of the first ply 11 include an end portion 11c that terminates on the outer side in the tire radial direction of the bead core 5. In other words, the first ply 11 is not wound up with respect to the bead core 5.

In the present embodiment, the end portion 11c of the side portion 11b of the first ply 11 is positioned closer to the inner side in the tire radial direction than the tip end 6b of the bead filler 6 and closer to the outer side in the tire radial direction than the base end 6a of the bead filler 6. That is, the side portion 11b of the first ply 11 overlaps the bead filler 6.

The second ply 12 is disposed adjacent to the outer side in the tire radial direction of the first ply 11, and is a discontinuous ply composed of a pair of the ply pieces 13 disposed separately on both sides in the tire width direction. A pair of the ply pieces 13 are configured similarly except for the positions of joint portions J2 and J3, which will be described later. The ply piece 13 has the inner end portion 13a disposed between the belt layer 20 and the central portion 11a of the first ply 11. The pad 40 is interposed between the inner end portion 13a and the belt layer 20. The position in the tire width direction of the inner end portion 13a of the ply piece 13 is set in the region on the outer side in the tire width direction of the tread portion 2, more specifically, in the region closer to the inner side in the tire width direction than both the end portions 21a and 22a of the belts 21 and 22 constituting the belt layer 20. The hollow portion 13c is provided in the region at the center in the tire width direction of the tread portion 2, more specifically, in the region between the inner end portions 13a of a pair of the ply pieces 13. In the hollow portion 13c, the second ply 12 does not exist, and only the central portion 11a of the first ply 11 exists.

The ply piece 13 includes a side portion 13b extending to the inner side in the tire radial direction from the inner end portion 13a. The side portion 13b is disposed adjacent to the outer side in the tire width direction of the side portion 11b of the first ply 11.

The ply piece 13 includes a wind-up portion 13d provided continuously with the side portion 13b and wound up from the inner side to the outer side in the tire width direction with respect to the bead core 5. The wind-up portion 13d is terminated in the sidewall portion 3.

The wind-up portion 13d of the ply piece 13 includes an inner portion 13e disposed closer to the inner side in the tire width direction than the bead portion 4, that is, the bead core 5 and the bead filler 6. Further, the wind-up portion 13d includes a winding portion 13f which is provided continuously with the inner portion 13e and is wound around the bead core 5. Further, the wind-up portion 13d includes an outer portion 13g which is provided continuously with the winding portion 13f and is disposed closer to the outer side in the tire width direction than the bead portion 4. The outer portion 13g is disposed so as to overlap the outer side in the tire radial direction of the side portion 13b. An end portion of the outer portion 13g constitutes an outer end portion 13h of the ply piece 13. The outer end portion 13h is positioned closer to the outer side in the tire radial direction than the tip end 6b of the bead filler 6 and is positioned closer to the inner side in the tire radial direction than the tread portion 2.

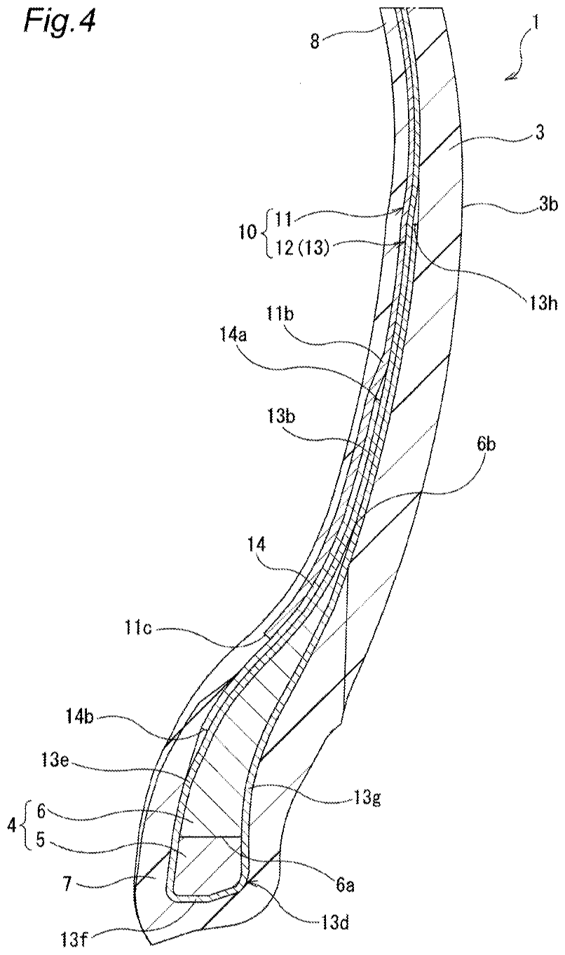

The pneumatic tire 1 includes a pair of joining tapes 14 that join either one of a pair of the side portions 11b of the first ply 11 to the wind-up portion 13d of either one of a pair of the ply pieces 13, more specifically, the inner portion 13e. As most clearly shown in FIG. 4, the joining tape 14 joins a portion including the end portion 11c of the side portion 11b of the first ply 11 to the inner portion 13e of the wind-up portion 13d of the ply piece 13.

The joining tape 14 is made from rubber and preferably has an adhesive strength of 500 gf or more in order to secure the joining strength of the first ply 11 to the second ply 12.

An end portion 14a on the outer side in the tire radial direction of the joining tape 14 is positioned closer to the outer side in the tire radial direction than the tip end 6b of the bead filler 6. The position in the tire radial direction of an end portion 14b on the inner side in the tire radial direction of the joining tape 14 is set between the base end 6a and the tip end 6b of the bead filler 6.

The end portion 11c of the first ply 11 is positioned between the end portion 14b on the inner side and the end portion 14b on the outer side in the tire width direction of the joining tape 14.

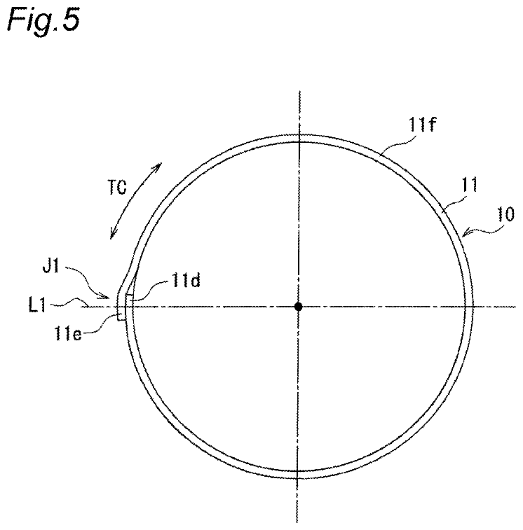

The pneumatic tire 1 according to the present embodiment will be further described with reference to FIGS. 5 to 7.

FIG. 5 shows a cross section of the first ply 11 of the carcass ply 10. As shown in FIG. 5, the first ply 11 of the carcass ply 10 is wound in a cylindrical shape, and one end portion 11d and the other end portion 11e are joined in a manner overlapping each other. A joint portion J1 in which the one end portion 11d and the other end portion 11e, which are both end portions in the circumferential direction of the first ply 11, are joined in a manner overlapping each other, is formed to be thicker than a non-joint portion 11f excluding the joint portion J1 of the first ply 11.

Each of a pair of the ply pieces 13 of the second ply 12 of the carcass ply 10 is also wound in a cylindrical shape in a similar manner to the first ply 11, and one end portion and the other end portion are joined in a manner overlapping each other. A joint portion in which the one end portion and the other end portion, which are both end portions in the circumferential direction of the ply piece 13, are joined in a manner overlapping each other, is formed to be thicker than a non-joint portion excluding the joint portion of the ply piece 13.

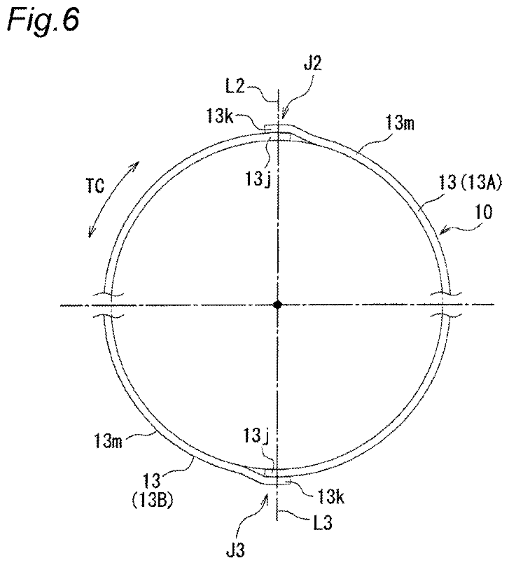

FIG. 6 shows a cross section of the second ply 12 of the carcass ply 10, and specifically shows a cross section of a pair of the ply pieces 13. In FIG. 6, cross sections of one and the other one of the ply pieces 13 along lines VIa-VIa and VIb-VIb of FIG. 2 are indicated by reference numerals 13A and 13B.

As shown in FIG. 6, the one ply piece 13A is wound in a cylindrical shape, and one end portion 13j and the other end portion 13k are joined in a manner overlapping each other. The joint portion J2 in which the one end portion 13j and the other end portion 13k, which are both end portions in the circumferential direction of the ply piece 13A, are joined in a manner overlapping each other, is formed to be thicker than a non-joint portion 13m excluding the joint portion J2 of the ply piece 13A.

As shown in FIG. 6, the other ply piece 13B is also wound in a cylindrical shape, and the one end portion 13j and the other end portion 13k are joined in a manner overlapping each other. The joint portion J3 in which the one end portion 13j and the other end portion 13k, which are both end portions in the circumferential direction of the ply piece 13B, are joined in a manner overlapping each other, is formed to be thicker than the non-joint portion 13m excluding the joint portion J3 of the ply piece 13B.

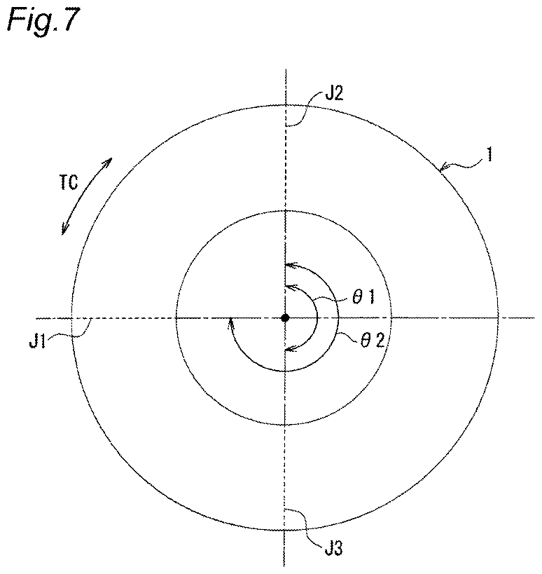

In FIG. 7, the joint portion of the first ply 11 is indicated by a broken line as J1, the joint portion of the one ply piece 13A of the second ply 12 is indicated by a broken line as J2, and the joint portion of the other ply piece 13B of the second ply 12 is shown by a broken line as J3. As shown in FIG. 7, the two joint portions J2 and J3 of a pair of the ply pieces 13 of the second ply 12 are provided at different positions in the tire circumferential direction TC, specifically, positions different by 180 degrees in the tire circumferential direction, which are on opposite sides in the tire circumferential direction.

The two joint portions J2 and J3 of the second ply 12 are provided at different positions in the tire circumferential direction from the joint portion J1 of the first ply 11. The two joint portions J2 and J3 of the second ply 12 are provided at positions different by 90 degrees in the tire circumferential direction from the joint portion J1 of the first ply 11.

As shown in FIG. 7, assuming that the position in the tire circumferential direction of the joint portion J2 of one of the ply pieces 13 of the second ply 12 around the axial direction of the pneumatic tire 1 is at 0 degrees, the joint portion J3 of the other one of the ply pieces 13 of the second ply 12 is provided so that a position θ1 in the tire circumferential direction is at 180 degrees, and the joint portion J1 of the first ply 11 is provided so that a position 92 in the tire circumferential direction is at 270 degrees. The first ply 11 and a pair of the ply pieces 13 of the second ply 12 are provided with the joint portions J1, J2, and J3 dispersed in the tire circumferential direction.

As shown in FIG. 5, the position in the tire circumferential direction of the joint portion J1 of the first ply 11 refers to an angular position of a center line L1 extending in the tire radial direction of the joint portion J1, and the center line L1 is a straight line that passes through the center of the tire and divides the joint portion J1 into two equal parts in the tire circumferential direction. The positions in the tire circumferential direction of the two joint portions J2 and J3 of a pair of the ply pieces 13 of the second ply 12 are also set in a similar manner to the first ply 11.

The joint portion J1 of the first ply 11 is preferably at a predetermined angle, for example, within an angle within 2 degrees, on one side and the other side in the tire circumferential direction with respect to the center line L1 of the joint portion J1. However, the configuration is not limited to this. The joint portions J2 and J3 of the second ply 12 are also preferably at a predetermined angle, for example, within an angle within 2 degrees, on one side and the other side in the tire circumferential direction with respect to center lines L2 and L3 of the joint portions J2 and J3. However, the configuration is not limited to this.

The two joint portions J2 and J3 of the second ply 12, which are provided at positions 180 degrees different from each other in the tire circumferential direction and are provided point-symmetrically in the tire circumferential direction, may be provided at different positions other than positions different by 180 degrees. Further, the two joint portions J2 and J3 of the second ply 12, which are provided at positions 90 degrees different from the joint portion J1 of the first ply 11 in the tire circumferential direction, may be provided at different positions other than positions different by 90 degrees.

Next, a manufacturing method of the pneumatic tire 1 configured in this way will be described.

When manufacturing the pneumatic tire 1, first, tire components for molding a cylindrical tread band, such as the tread rubber 2b constituting the tread portion 2 and the belts 21 and 22, are prepared. On the other hand, tire components for molding a cylindrical carcass band, such as the carcass ply 10 that includes the first ply 11 and the second ply 12 and is stretched between a pair of the bead cores 5 and the inner liner 8, are prepared.

Then, tire components such as the inner liner 8 and the carcass ply 10 are wound around a molding drum to mold a cylindrical carcass band. In the molding of the carcass band, the first ply 11 is supplied to the molding drum and the first ply 11 is wound in a cylindrical shape, and the joint portion J1 in which both the end portions 11d and 11e in the circumferential direction of the first ply 11 are joined in a manner overlapping each other is formed.

Next, one of the ply pieces 13 of the second ply 12 is supplied to the molding drum and wound in a cylindrical shape and the joint portion J2 in which both end portions in the circumferential direction of the one of the ply pieces 13 are joined in a manner overlapping each other is formed, and the other one of the ply pieces 13 of the second ply 12 is supplied to the molding drum and wound in a cylindrical shape and the joint portion J3 in which both end portions in the circumferential direction of the other one of the ply pieces 13 are joined in a manner overlapping each other is formed. One and the other one of the ply pieces 13 of the second ply 12 disposed separately in the tire width direction are simultaneously supplied and wound by using a manufacturing device 50 for a pneumatic tire described later.

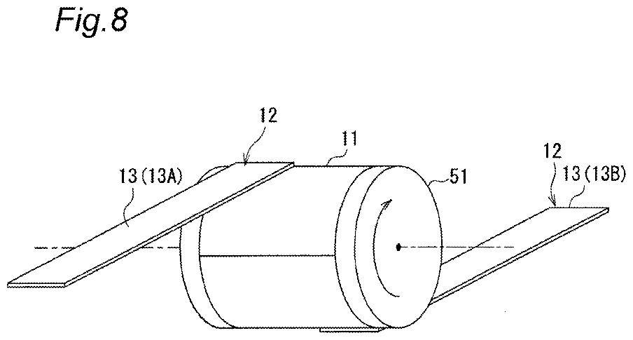

As shown in FIG. 8, a molding drum 51 around which a pair of the ply pieces 13 of the second ply 12 are wound is rotationally driven, the one ply piece 13A is supplied to the molding drum 51 from the upper side, and the other ply piece 13B is supplied to the molding drum 51 from the lower side. The one and the other ply pieces 13A and 138 are simultaneously supplied to the molding drum 51 and wound so that the two joint portions J2 and J3, which are joined as both end portions in the tire circumferential direction overlap each other, are provided at different positions in the tire circumferential direction.

The one and the other ply pieces 13A and 13B are simultaneously supplied to and wound around the molding drum 51, specifically the first ply 11 wound around the molding drum 51. Although not shown, the joining tape 14 for joining to the first ply 11 is attached to each of the one and the other ply pieces 13A and 138. The one and the other ply pieces 13A and 138 are simultaneously supplied to the molding drum 51 and wound with the joining tape 14 attached.

When the carcass band is molded, the carcass band is transferred to another molding drum, and, after that, the bead core 5 and bead filler 6 are assembled on both side portions of the carcass band, and the carcass band is folded back on both sides in the drum width direction around the bead core 5, so that a cylindrical green case is molded.

On the other hand, tire components such as a belt and tread rubber are further wound around another molding drum to mold a cylindrical tread band. Then, after the tread band is transported to the outer side in the radial direction of the green case, the green case is bulged in a toroidal shape to the outer side in the radial direction, the outer surface of the green case is bonded to the inner surface of the tread band, and a carcass tread bond body is molded.

Next, a pair of sidewall rubbers 9 are wound around the carcass tread bond body to mold a green tire. The molded green tire is vulcanized and molded by a vulcanization molding machine (not shown) including a tire vulcanization mold, and the pneumatic tire 1 is manufactured.

A pair of the sidewall rubbers 9 are wound and molded after the carcass tread bond body is molded. However, it is also possible to wind and mold the sidewall rubber 9 when the carcass band is molded.

In the present embodiment, the second ply 12 includes the wind-up portion 13d wound up with respect to the bead core 5, and, although the first ply 11 is not wound up with respect to the bead core 5, the first ply 11 can include a wind-up portion that is wound up with respect to the bead core 5. Further, both the first ply 11 and the second ply 12 may include a wind-up portion wound up with respect to the bead core 5.

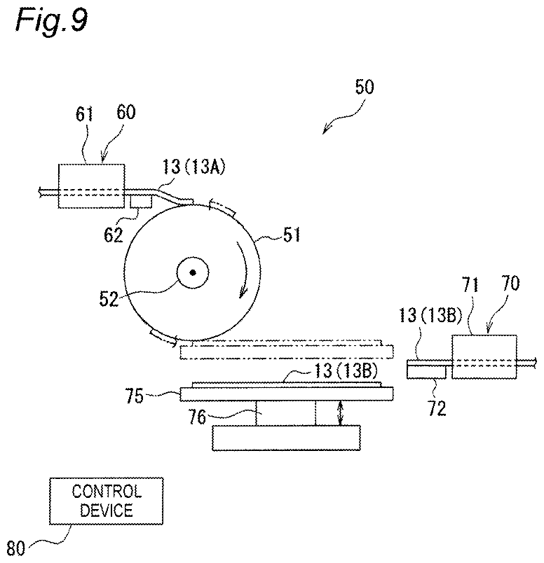

The manufacturing device for a pneumatic tire according to the present embodiment will be described with reference to FIG. 9.

As shown in FIG. 9, the manufacturing device 50 for a pneumatic tire for manufacturing a pneumatic tire molds a cylindrical carcass band by winding tire components such as the inner liner 8 and the carcass ply 10 sequentially, specifically, winds the second ply 12 of the carcass ply 10 around the first ply 11.

The manufacturing device 50 includes the molding drum 51 around which a pair of the ply pieces 13 of the second ply 12 are wound, a drum drive device 52 for rotationally driving the molding drum 51, a first supply device 60 that supplies one of the ply pieces 13 to the molding drum 51, and a second supply device 70 that supplies the other one of the ply pieces 13 to the molding drum 51.

Tire components such as the inner liner 8 and the first ply 11 of the carcass ply 10 disposed on the inner side in the tire radial direction of the second ply 12 are wound around the molding drum 51 before a pair of the ply pieces 13 of the second ply 12 are wound.

As the drum drive device 52, a motor 52 that rotationally drives the molding drum 51 is used. As the drum drive device 52, it is also possible to use another drum drive device that rotationally drives the molding drum 51 instead of the motor.

The first supply device 60 includes a servicer 61 that supplies the one ply piece 13A to the molding drum 51 from the upper side, and a guide portion 62 that guides the one ply piece 13A. The first supply device 60 has a configuration in which the one ply piece 13A supplied from the servicer 61 is guided by the guide portion 62 and supplied to the molding drum 51 from the upper side.

The second supply device 70 includes a servicer 71 that supplies the other ply piece 13B to the molding drum 51 from the lower side, and a guide portion 72 that guides the other ply piece 13B. The second supply device 70 also includes a holding portion 75 that holds the other ply piece 13B supplied from the servicer 71, and a holding portion moving mechanism 76 that moves the holding portion 75 in the vertical direction.

As the holding portion moving mechanism 76, a cylinder 76 configured to be able to move the holding portion 75 in the vertical direction is used. As the holding portion moving mechanism 76, it is also possible to use another holding portion moving mechanism that moves the holding portion 75 in the vertical direction instead of the cylinder.

The second supply device 70 has a configuration, in which the other ply piece 13B supplied from the servicer 71 is guided by the guide portion 72 and supplied to the upper surface of the holding portion 75 at the lower side position shown by the solid line in FIG. 9. The holding portion 75 holding the other ply piece 13B is moved by the cylinder 76 to the upper side position shown by the alternate long and short dash line in FIG. 9, and the other ply piece 13B is supplied to the molding drum 51 from the lower side. The joining tape 14 is attached to each of the one and the other ply pieces 13.

The manufacturing device 50 includes a control device 80 that controls the operation of the drum drive device 52, the first supply device 60, the second supply device 70, and the like. The control device 80 controls the operation of the motor 52 as the drum drive device 52, the servicer 61 of the first supply device 60, the servicer 71 of the second supply device 70, the cylinder 76, and the like. The control device 80 is configured with, for example, a microcomputer as a main part.

The control device 80 controls operation of the drum drive device 52, the first supply device 60, and the second supply device 70 so that the one and the other ply pieces 13A and 13B are supplied simultaneously to the molding drum 51 while the molding drum 51 is rotationally driven, and the two joint portions J2 and J3 where both end portions in the tire circumferential direction of the one and the other ply pieces 13A and 13B are joined in a manner overlapping each other are provided at different positions in the tire circumferential direction TC.

The control device 80 causes the first supply device 60 to supply the one ply piece 13A from the upper side to the molding drum 51, specifically, the molding drum 51 around which the first ply 11 is wound. The control device 80 also causes the second supply device 70 to supply the other ply piece 13B from the lower side to the molding drum 51, specifically, the molding drum 51 around which the first ply 11 is wound. A tip end portion of the one ply piece 13A and a tip end portion of the other ply piece 13B are supplied to positions separated from each other in the width direction and different by 180 degrees in the circumferential direction on the molding drum 51.

Then, the control device 80 operates so that the one and the other ply pieces 13A and 13B are supplied to the molding drum 51 while causing the molding drum 51 to be rotationally driven in the direction indicated by the arrow in FIG. 9. The one and the other ply pieces 13A and 13B are wound around the molding drum 51 as shown by the alternate long and short dash line in FIG. 9, and the two joint portions J2 and J3 where both end portions in the tire circumferential direction of the one and the other ply pieces 13A and 13B are joined in a manner overlapping each other are provided to positions separated from each other in the tire width direction and different in the tire circumferential direction, specifically, at positions different by 180 degrees in the tire circumferential direction.

The first supply device 60 has a configuration, in which the servicer 61, which supplies the one ply piece 13A to the molding drum 51 from the upper side, cuts a strip-shaped ply piece sheet wound by the winding device to a predetermined length by a cutting device to supply the one ply piece 13A. The servicer 61 can also be configured to supply the one ply piece 13A previously cut to a predetermined length.

The second supply device 70 has a configuration, in which the servicer 71, which supplies the other ply piece 13B to the molding drum 51 from the lower side, cuts a strip-shaped ply piece sheet wound by the winding device to a predetermined length by a cutting device to supply the other ply piece 13B. The servicer 71 can also be configured to supply the other ply piece 13B previously cut to a predetermined length.

The second supply device 70 is configured to hold the other ply piece 13B supplied from the servicer 71 in the holding portion 75 and then supply the other ply piece 13B to the molding drum 51. However, the second supply device 70 may be configured to supply the other ply piece 13B supplied from the servicer 71 to the molding drum 51 from the lower side without holding the other ply piece 13B in the holding portion.

Further, the manufacturing device 50 has a configuration in which the one and the other ply pieces 13 are supplied to the molding drum 51 at positions different by 180 degrees in the circumferential direction on the upper side and the lower side. However, it is also possible to supply the one and the other ply pieces 13 at different angle positions other than positions different by 180 degrees on the upper side and the lower side to the molding drum 51.

As described above, in the manufacturing device 50, when the second ply 12 is wound on the first ply 11 around the molding drum 51 and the carcass band is molded, the carcass band is transferred to another molding drum and a cylindrical green case is molded. Then, the green case is bulged outward in a toroidal shape to the outer side in the radial direction and bonded to the inner surface of a tread band so that a green tire is molded. The molded green tire is vulcanized and molded to produce the pneumatic tire 1.

In the pneumatic tire 1, the joining tape 14 for joining the first ply 11 and the second ply 12 is provided on the center side in the width direction of a pair of the ply pieces 13 of the second ply 12. However, the joining tape 14 can be provided in other portions, such as the end portion side in the width direction of a pair of the ply pieces 13. Further, it is also possible not to use the joining tape for joining the first ply 11 and the second ply 12.

As described above, in the present embodiment, the manufacturing device 50 for a pneumatic tire in which the carcass ply 10 includes the pair of ply pieces 13 includes the molding drum 51, the drum drive device 52, the first supply device 60 for supplying one of the ply pieces 13 to the molding drum 51, the second supply device 70 for supplying the other one of the ply pieces 13 to the molding drum 51, and the control device 80 that controls operation of the drum drive device 52 and the first and second supply devices 60 and 70 so that the one and the other one of the ply pieces 13 are simultaneously supplied to the molding drum 51 while the molding drum is rotationally driven, and the two joint portions J2 and J3 of the one and the other ply pieces 13 are provided at different positions in the tire circumferential direction TC.

In this manner, in the pneumatic tire 1, in a case where the carcass ply 10 includes a pair of the ply pieces 13 disposed separately on both sides in the tire width direction, the two joint portions J2 and J3 of a pair of the ply pieces 13 are provided at different positions in the tire circumferential direction TC. For this reason, as compared with the case where the two joint portions J2 and J3 are provided at the same position in the tire circumferential direction TC, the joint portions J2 and J3 are dispersed in the tire circumferential direction TC and uniformity in the tire circumferential direction TC of the pneumatic tire 1 can be improved.

The joint portions J2 and J3 of the ply piece 13 have increased rigidity as compared with the non-joint portion 13m of the ply piece 13. For this reason, the joint portions J2 and J3 of the ply piece 13 are less likely to bulge and deform than the non-joint portion 13m when the tire is filled with internal pressure and bulged and deformed. Therefore, the joint portions J2 and J3 of the ply piece 13 may appear as dents in the pneumatic tire 1.

By providing the two joint portions J2 and J3 of a pair of the ply pieces 13 at different positions in the tire circumferential direction TC, the dents caused by the joint portions J2 and J3 are dispersed in the tire circumferential direction TC and uniformity in the tire circumferential direction can be improved as compared with the case where the two joint portions J2 and J3 are provided at the same position in the tire circumferential direction TC.

In the manufacturing of the pneumatic tire 1, the one and the other ply pieces 13 are simultaneously supplied to the molding drum 51 while the molding drum 51 is rotationally driven, so that the supply time for supplying the one and the other ply pieces 13 to the molding drum 51 can be shortened and the manufacturing can be performed with excellent productivity, as compared with the case where the one and the other ply pieces 13 are sequentially supplied to the molding drum 51. Therefore, the pneumatic tire 1 can be manufactured with excellent productivity while the uniformity in the tire circumferential direction TO is improved.

Further, the carcass ply 10 includes the first ply 11 including the central portion 11a positioned on the inner side in the tire radial direction of the tread portion 2 and a pair of the side portions 11b extending to the inner side in the tire radial direction from both ends of the central portion 11a, and the second ply 12 having a pair of the ply pieces 13 including the inner end portion 13a disposed on the outer side in the tire radial direction with respect to the first ply 11 and positioned in the tread portion 2 and the side portion 13b extending to the inner side in the tire radial direction from the inner end portion 13a. The one and the other ply pieces 13 of the second ply 12 are supplied on the first ply 11 wound around the molding drum 51.

The second ply 12 on the first ply 11 includes a pair of the ply pieces 13 and is discontinuous. That is, between the inner end portions 13a of a pair of the ply pieces 13, there is the hollow portion 13c in which no ply exists. By employing the second ply 12 having the hollow portion 13c, the weight can be reduced as compared with the case where the second ply 12 is one continuous ply. Further, rolling resistance can be reduced by weight reduction.

In the sidewall portion 3, two layers of plies, that is, the side portion 11b of the first ply 11 and the side portion 13b of the ply piece 13 of the second ply 12 are disposed. By providing two layers of plies in the sidewall portion 3 in this way, necessary cut resistance is ensured. Further, since plies are provided in two layers, necessary rigidity in the sidewall portion 3 is ensured.

Therefore, it is possible to achieve weight reduction and reduction in rolling resistance due to the weight reduction while ensuring the rigidity and the steering stability due to the rigidity and the cut resistance, and, in addition, to manufacture the pneumatic tire 1 with excellent productivity while achieving improvement in uniformity in the tire circumferential direction TC.

Further, the first supply device 60 supplies one of the ply pieces 13 to which the joining tape 14 to be joined to the first ply 11 is attached, and the second supply device 70 supplies the other one of the ply pieces 13 to which the joining tape 14 to be joined to the first ply 11 is attached. In this manner, the one and the other ply pieces 13 of the second ply 12 to which the joining tape 14 is attached are supplied on the first ply 11, so that the first ply 11 and the second ply 12 can be joined strongly by the joining tape 14.

Further, the first supply device 60 and the second supply device 70 supply one and the other one of the ply pieces 13 to the molding drum 51 from the upper side and the lower side, respectively, and the control device 80 controls operation of the drum drive device 52, the first supply device 60, and the second supply device 70 so that the two joint portions J2 and J3 of one and the other one of the ply pieces 13 are provided at positions different by 180 degrees in the tire circumferential direction TC. In this manner, one and the other one of the ply pieces 13 are supplied to the molding drum 51 from the upper side and the lower side, respectively, and the two joint portions J2 and J3 are provided at positions different by 180 degrees in the tire circumferential direction TC, so that the two joint portions J2 and J3 can be effectively dispersed in the tire circumferential direction TC, and the pneumatic tire 1 can be manufactured with excellent productivity while the uniformity in the tire circumferential direction TC is improved.

Further, the second supply device 70 includes the holding portion 75 that is disposed below the molding drum 51 and holds the other one of the ply pieces 13, and the holding portion moving mechanism 76 that moves the holding portion 75 in the vertical direction. The holding portion 75 holding the other one of the ply pieces 13 is moved to the upper side by the holding portion moving mechanism 76 to supply the other one of the ply pieces 13 to the molding drum 51. In this manner, in a case where the other one of the ply pieces 13 of the second ply 12 is supplied to the molding drum 51 from the lower side, the other one of the ply pieces 13 is moved upward while being held by the holding portion 75 and supplied to the molding drum 51. Accordingly, the other one of the ply pieces 13 can be stably supplied to the molding drum 51.

Further, in the present embodiment, in the manufacturing method for the pneumatic tire 1 in which the carcass ply 10 includes a pair of the ply pieces 13, the molding drum 51 is rotationally driven, the one and the other one of the ply pieces 13 are supplied to the molding drum 51, and the one and the other one of the ply pieces 13 are simultaneously supplied to the molding drum 51 while the molding drum 51 is rotationally driven so that the two joint portions J2 and J3 of the one and the other one of the ply pieces 13 are provided at different positions in the tire circumferential direction TC.

In this manner, in the pneumatic tire 1, in a case where the carcass ply 10 includes a pair of the ply pieces 13 disposed separately on both sides in the tire width direction, the two joint portions J2 and J3 of a pair of the ply pieces 13 are provided at different positions in the tire circumferential direction TC. For this reason, as compared with the case where the two joint portions J2 and J3 are provided at the same position in the tire circumferential direction TC, the joint portions J2 and J3 are dispersed in the tire circumferential direction TC and uniformity in the tire circumferential direction TC of the pneumatic tire 1 can be improved.

The joint portions J2 and J3 of the ply piece 13 have increased rigidity as compared with the non-joint portion 13m of the ply piece 13. For this reason, the joint portions J2 and J3 of the ply piece 13 are less likely to bulge and deform than the non-joint portion 13m when the tire is filled with internal pressure and bulged and deformed. Therefore, the joint portions J2 and J3 of the ply piece 13 may appear as dents in the pneumatic tire 1.

By providing the two joint portions J2 and J3 of a pair of the ply pieces 13 at different positions in the tire circumferential direction TC, the dents caused by the joint portions J2 and J3 are dispersed in the tire circumferential direction TC and uniformity in the tire circumferential direction can be improved as compared with the case where the two joint portions J2 and J3 are provided at the same position in the tire circumferential direction TC.

In the manufacturing of the pneumatic tire 1, the one and the other ply pieces 13 are simultaneously supplied to the molding drum 51 while the molding drum 51 is rotationally driven, so that the supply time for supplying the one and the other ply pieces 13 to the molding drum 51 can be shortened and the manufacturing can be performed with excellent productivity, as compared with the case where the one and the other ply pieces 13 are sequentially supplied to the molding drum 51. Therefore, the pneumatic tire 1 can be manufactured with excellent productivity while the uniformity in the tire circumferential direction TC is improved.

The present invention is not limited to the illustrated embodiment, and various improvements and design changes can be made without departing from the gist of the present invention.

What is claimed is:

1. A manufacturing device for a pneumatic tire including a carcass ply stretching between a pair of bead cores disposed on both sides in a tire width direction, the carcass ply including a pair of ply pieces disposed separately on both sides in the tire width direction, the manufacturing device comprising:
a molding drum;
a drum drive device that rotationally drives the molding drum;
a first supply device that supplies one ply piece of the pair of ply pieces to the molding drum;
a second supply device that supplies the other ply piece of the pair of ply pieces to the molding drum; and
a control device that controls operation of the drum drive device, the first supply device, and the second supply device so that the one and the other ply pieces are simultaneously supplied to the molding drum while the molding drum is rotationally driven, and two joint portions in which both end portions in a tire circumferential direction of the one and the other ply pieces are joined in a manner overlapping each other are provided at different positions in the tire circumferential direction.

2. The manufacturing device for a pneumatic tire according to claim 1, wherein
the carcass ply includes a first ply including a central portion positioned on an inner side in a tire radial direction of a tread portion and a pair of side portions extending to an inner side in the tire radial direction from both ends of the central portion, and a second ply having the pair of ply pieces, each of which including an inner end portion disposed on an outer side in the tire radial direction with respect to the first ply and positioned in the tread portion and a side portion extending to an inner side in the tire radial direction from the inner end portion, and
the control device controls operation of the first supply device and the second supply device so that the one and the other ply pieces are supplied on the first ply wound around the molding drum.

3. The manufacturing device for a pneumatic tire according to claim 2, wherein
the control device controls operation of the drum drive device, the first supply device, and the second supply device so that the two joint portions of the one and the other one ply pieces are provided at different positions in the tire circumferential direction from a joint portion in which both end portions in the tire circumferential direction of the first ply are joined in a manner overlapping each other.

4. The manufacturing device for a pneumatic tire according to claim 2, wherein
the first supply device supplies the one ply piece to which a joining tape to be joined to the first ply is attached, and
the second supply device supplies the other ply piece to which a joining tape to be joined to the first ply is attached.

5. The manufacturing device for a pneumatic tire according to claim 1, wherein
the first supply device supplies the one ply piece to the molding drum from an upper side,
the second supply device supplies the other ply piece to the molding drum from a lower side, and
the control device controls operation of the drum drive device, the first supply device, and the second supply device so that two joint portions of the one and the other ply pieces are provided at positions different by 180 degrees in a tire circumferential direction.

6. The manufacturing device for a pneumatic tire according to claim 5, wherein
the second supply device includes
a holding portion that is disposed below the molding drum and holds the other ply piece, and
the holding portion moving mechanism that moves the holding portion in a vertical direction, wherein
the holding portion holding the other ply piece is moved to an upper side by the holding portion moving mechanism to supply the other ply piece to the molding drum.

7. A manufacturing method for a pneumatic tire including a carcass ply stretching between a pair of bead cores disposed on both sides in a tire width direction, the carcass ply including a pair of ply pieces disposed separately on both sides in the tire width direction, the manufacturing method comprising:
rotationally driving a molding drum;
supplying one ply piece of the pair of ply pieces to the molding drum; and
supplying the other ply piece of the pair of ply pieces to the molding drum,
wherein the one and the other ply pieces are simultaneously supplied to the molding drum while the molding drum is rotationally driven, so that two joint portions in which both end portions in a tire circumferential direction of the one and the other ply pieces are joined in a manner overlapping each other are provided at different positions in the tire circumferential direction.
